(19) United States
(12) Patent Application Publication
(10) Pub. No.: US 2006/0262059 A1
(43) Pub. Date: Nov. 23, 2006

(54) Drive circuit for display apparatus and driving method

(75) Inventors: Yoshiharu Hashimoto, Kanagawa (JP); Takashi Tahata, Kanagawa (JP); Masayuki Kumeta, Kanagawa (JP); Yutaka Yamagami, Kanagawa (JP); Hisanao Kato, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/437,609

(22) Filed: May 22, 2006

(30) Foreign Application Priority Data
May 23, 2005 (JP) 2005-150024

(51) Int. Cl. G09G 3/36

(52) U.S. Cl. 345/89

(57) ABSTRACT

A drive circuit includes a logic section having a data bus and a display memory circuit and configured to read out a plurality of gradation data from the display memory circuit through the data bus and to collectively output the plurality of gradation data as display pixel data; and a drive section configured to drive a display unit based on analog gradation signals which are generated based on the display pixel data outputted from the logic section. The drive circuit further includes a power supply circuit configured to supply at least one of first and second power supply voltages to the logic section and the drive section. The logic section, the drive section and the power supply circuit may be formed in a same semiconductor chip.

### BACKGROUND OF THE INVENTION

1. Field of the Invention

The present invention relates to a drive circuit for a display apparatus, and more particularly to a drive circuit having a display memory for a display apparatus and a semiconductor device having the drive circuit integrated therein.

2. Description of the Related Art

A liquid crystal display apparatus has prevailed as a type of display apparatus. Such a liquid crystal display apparatus has been adopted in various kinds of electronic equipment such as a mobile phone from its features of low power consumption, a light weight and thinness. A drive system for the liquid crystal display apparatus is classified into a simple matrix type and an active matrix type using an active device such as a thin film transistor (TFT) for a pixel circuit. The display apparatus displays a variety of video images in response to a digital signal supplied from a CPU in a mobile phone or the like. The digital signal includes a digital gradation signal of k bits representing the contrast of a color in each of pixels and control signals such as a command signal and a standby signal.

A drive circuit for driving a display apparatus is disclosed in Japanese Laid Open Patent Publication (JP-A-Heisei 7-281634), in which the drive circuit incorporates a display memory circuit. FIG. 1 shows the drive circuit disclosed in the above conventional example, which is exemplified by a conventional data line drive circuit 81. The data line drive circuit 81 has a logic unit 88 and a drive unit 89 for driving a panel 3. In the logic unit 88, a display memory (RAM) circuit 83 stores gradation data for one frame or less. Addresses of the display memory circuit 83 for one display line are selected from a first address to a last n-th address in response to an address control signal supplied from a signal processing circuit 82, and then n gradation data for one display line of the panel 3 are read out from the display memory circuit 83 at one time based on the selected n addresses, and outputted to a latch circuit B 16. The latch circuit B 16 holds the n gradation data, and then outputs the n gradation data to a data calculating circuit 84 at one time in response to a latch signal (i.e., an STB signal) as a latch clock from the signal processing circuit 82.

The data calculating circuit 84 carries out a predetermined logic calculating process on each of the n gradation data, and then supplies a signal as the calculation result to a D/A converting circuit 18 through a level shift circuit 17 in the drive unit 89. The predetermined logic calculating process is at least one of a polarity reverting process POL, a reverting process REV, an all-black process DISP0 and an all-white process DISP1. The process is designated in response to a logic calculating process instruction issued from the signal processing circuit 82. The polarity reverting process POL is a process of reverting the gradation data in order to AC-drive a liquid crystal. The reverting process REV is a process of reverting a display color of a video image to a completely contrary color. The all-black or all-white process is a process of converting a signal indicating black or white into a signal indicating white or black, and vice versa, irrespective of the gradation data.

The D/A converting circuit 18 in the drive unit 89 selects one of a plurality of gradation voltages supplied from a gradation voltage generating circuit 19, based on each of the gradation data from the data calculating circuit 84, and then has supplied the selected gradation voltages to first to n-th pixels of one display line in the panel 3 through data lines Y1 to Yn, respectively.

However, the gradation data for one display line of the panel 3 are read out from the display memory circuit 83 at one time in the logic unit 88, and then supplied to the latch circuit B 16. Also, the display memory circuit 83 is provided with (k bits×n) sense amplifiers. As a consequence, when the logic calculating process is carried out to the gradation data for every pixel in the data calculating circuit 84 and the (k bits×n) sense amplifiers are operated, a peak value of a circuit current in the logic unit 88 becomes large. Also, noise is propagated to a Vcom voltage supplied to a common electrode in the display panel 3 from a power source circuit, resulting in degradation of a quality of an image caused by a horizontal stripe or a flicker. Moreover, since the data calculating circuit 84 carries out the logic calculating process such as the polarity reverting process to the gradation data for one display line at one time, the circuit size of the data calculating circuit 84 increases.

### SUMMARY OF THE INVENTION

In an aspect of the present invention, a drive circuit includes a logic section having a data bus and a display memory circuit and configured to read out a plurality of gradation data from the display memory circuit through the data bus and to collectively output the plurality of gradation data as display pixel data; and a drive section configured to drive a display unit based on analog gradation signals which are generated based on the display pixel data outputted from the logic section.

Here, the drive circuit may further include a power supply circuit configured to supply at least one of first and second power supply voltages to the logic section and the drive section. The logic section, the drive section and the power supply circuit may, be formed in a same semiconductor chip.

Also, the logic section may include p sense amplifiers (p is a natural number) provided between the display memory circuit and the data bus; and a buffer circuit configured to output the plurality of gradation data read out from the display memory circuit onto the data bus in units of p pixels.

Also, the display memory circuit may include memory cells arranged in a matrix; and a column decoder configured to sequentially generate sampling signals to columns of the matrix in response to a horizontal clock signal. The buffer circuit may include a switch section provided between the columns and the sense amplifier and configured to operate in response to the sampling signals. The plurality of gradation data read out from the display memory circuit may be sequentially outputted the p sense amplifiers.

Also, the logic section may include a data calculating circuit configure to carry out a first calculation to each of the plurality of gradation data, to selectively generate a process instruction based on a result of the first calculation and to output the first calculation result and the process instruction; and a first holding circuit configured to hold the first calculation result for one display line of the display unit, to carry out a second calculation to the first calculation result held therein when the process instruction is outputted, and to hold and output a second calculation result as the display pixel data.

In this case, it is preferable that the first calculation is a majority operation between a previous gradation data and a current gradation data.

The data bus may include a first data bus on which the plurality of gradation data are outputted from the sense amplifiers; and a second data bus on which the second calculation result and the process instruction are outputted from the data calculating circuit.

Also, the data calculating circuit may include a second holding circuit configured to hold the second calculation result and the process instruction to output onto the second data bus; and a majority operation circuit configured to execute the majority operation of whether bits inverted between the second calculation result and the current gradation data is major and to output the process instruction to the second holding circuit when the inverted bits are major.

Here, the data calculating circuit may further include a logic circuit configured to carry out a conversion to the current gradation data on the first data bus in response to a mode instruction to output to the majority operation circuit.

Also, the data bus may be a single bus. In this case, the data calculating circuit may include a second holding circuit configured to hold and output the first calculation result and the process instruction to the data bus; and a majority operation circuit configured to carry out a majority operation of whether bits inverted between the first calculation result to the previous gradation data and the current gradation data is major, and to generate and output the process instruction to the second holding circuit when the inverted bits are major.

In this case, the data calculating circuit may further include a logic circuit configured to carry out a conversion process to the current gradation data on the data bus in response to a mode indication to output to the majority operation circuit.

Also, the drive section may include a level shift circuit configured to carry out a level shift of the display pixel data for one display line of the display unit; a gradation voltage generating circuit configured to generate gradation voltages for a predetermined number; and a D/A converting circuit provided for each of the columns and configured to select one of the gradation voltages for the predetermined number based on each of the display pixel data after the level shift and to drive the display unit based on the selected gradation voltage.

Also, the D/A converting circuit may include a decoder circuit configured to decode the display pixel data; a selector configured to select one of the gradation voltages for the predetermined number based on the decoding result; and a switch section configured to supply the selected gradation voltage to the display unit.

Also, the gradation voltage generating circuit may include at least two reference voltages; and a voltage dividing resistance circuit configured to divide a reference voltage difference.

Also, the data calculating circuit may further include a data distinction circuit provided between the logic circuit and the majority operation circuit and configured to decode the plurality of gradation data to output a distinction signal while outputting the plurality of gradation data from the logic circuit to the majority operation circuit. The gradation voltage generating circuit may include at least two reference voltages; a voltage dividing resistance circuit configured to divide a reference voltage difference; a group of buffer amplifiers configured to amplify an output of the voltage dividing resistance circuit; and a bias voltage control circuit configured to activate one of the buffer amplifiers of the group based on the distinction signal such that the gradation voltage corresponding to the display pixel data is outputted.

Also, the D/A converting circuit may include a decoder configured to decode the display pixel data; and a selector configured to supply one of the gradation voltages for the predetermined number to the display unit based on the decoding result.

In another aspect of the present invention, a driving method of a display unit is achieved by sequentially reading out a plurality of gradation data in units of p pixels (p is a natural number) from a display memory circuit; by generating display pixel data obtained by carrying out a calculation process to the plurality of gradation data; and by driving the display unit in response to analog gradation signals generated based on the display pixel data.

Here, the generating may be achieved by carrying out a first calculation to each of the plurality of gradation data; by selectively generating a process instruction based on a result of the first calculation; by holding the first calculation result for one display line of the display unit; by carrying out a second calculation to the first calculation result in response to the process instruction; and by generating a second calculation result as the display pixel data.

Also, the first calculation may be a majority operation between a previous gradation data and a current gradation data.

### BRIEF DESCRIPTION OF THE DRAWINGS

FIG. 1 is a block diagram illustrating the configuration of a conventional drive circuit for a display apparatus;

FIG. 2 is a block diagram illustrating the configuration of a display apparatus, to which the present invention is applied;

FIG. 3 is a block diagram illustrating the configuration of a drive circuit for the display apparatus according to a first embodiment of the present invention;

FIG. 4 is a block diagram illustrating a display memory circuit and a buffer circuit in the drive circuit for the display apparatus according to the first embodiment of the present invention;

FIG. 5 is a block diagram illustrating a data calculating circuit in the drive circuit for the display apparatus according to the first embodiment of the present invention;

FIG. 6 is a block diagram illustrating a gradation voltage generating circuit in the drive circuit for the display apparatus according to the first embodiment of the present invention;

FIG. 7 is a block diagram illustrating a D/A converting circuit in the drive circuit for the display apparatus according to the first embodiment of the present invention;

FIGS. 8A to 8H are timing charts illustrating the operation of the drive circuit for the display apparatus according to the first embodiment of the present invention;

FIG. 9 is a diagram illustrating an example of a circuit arrangement, in which the drive circuit for the display apparatus according to the first embodiment of the present invention is integrated;

FIG. 10 is a diagram illustrating another example of a circuit arrangement, in which the drive circuit for the display apparatus according to the first embodiment of the present invention is integrated;

FIG. 11 is a block diagram illustrating the configuration of the drive circuit for the display apparatus according to a second embodiment of the present invention;

FIGS. 12A to 12G are timing charts illustrating the operation of the drive circuit for the display apparatus according to the second embodiment of the present invention;

FIG. 13 is a block diagram illustrating the configuration of the drive circuit for the display apparatus according to a third embodiment of the present invention;

FIG. 14 is a block diagram illustrating the data calculating circuit in the drive circuit for the display apparatus according to the third embodiment of the present invention;

FIG. 15 is a block diagram illustrating the gradation voltage generating circuit in the drive circuit for the display apparatus according to the third embodiment of the present invention;

FIG. 16 is a block diagram illustrating a D/A converting circuit in the drive circuit for the display apparatus according to the third embodiment of the present intention;

FIG. 17 is a block diagram illustrating the drive circuit for the display apparatus according to a fourth embodiment of the present invention; and

FIG. 18 is a block diagram illustrating the buffer circuit in the drive circuit for the display apparatus according to the fourth embodiment of the present invention.

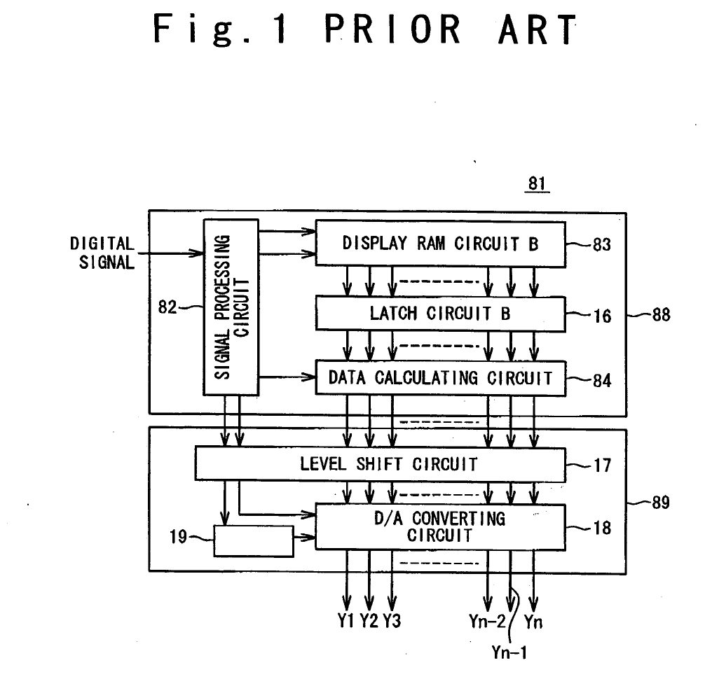

### DESCRIPTION OF THE PREFERRED EMBODIMENTS

Hereinafter, a drive circuit for a display apparatus according to the present invention will be described in detail with reference to the attached drawings by using embodiments. However, the present invention is not limited to these embodiments.

### First Embodiment

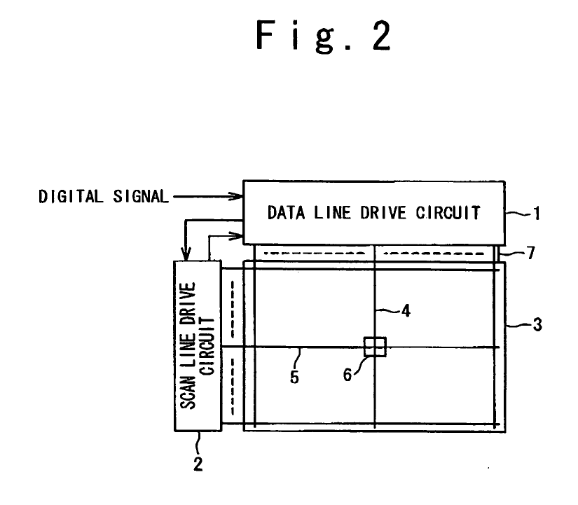

FIG. 2 is a block diagram showing the drive circuit according to the first embodiment of the present invention. Referring to FIG. 2, the drive circuit according to the first embodiment of the present invention can be applied to a display apparatus of a mobile phone. The display apparatus is provided with a data line drive circuit 1, a scanning line drive circuit 2 and a display panel 3. The data line drive circuit 1 incorporates a display memory (RAM) circuit 13. The display apparatus receives a digital signal from a CPU (not shown) in the mobile phone or the like. Examples of such a digital signal include a digital gradation data signal of 6 bits representing a contrast of a color of each of pixels and control signals such as an address control signal for designating a region of the display memory circuit 13 for the gradation data to be written in, a command signal and a standby signal.

The display memory circuit 13 stores the gradation data for one frame. In the drive circuit for the display apparatus used in the mobile phone, the display memory circuit 13 is included in the data line drive circuit 1. When a next frame display is not changed from a current frame display, the supply of the digital signal of a next frame from the CPU to the display apparatus is stopped to reduce consumed power at an interface between the CPU and the display apparatus. Otherwise, when only a part of a region for the next frame display is changed from the current frame display, an address control signal for the region and the gradation data corresponding to the region are supplied. As a consequence, a processing burden imposed on the CPU can be reduced. Although the first embodiment is directed to the display memory circuit 13 having a memory capacity for one frame, the memory capacity may be more than one frame or less than one frame. A memory having a memory capacity less than one frame is exemplified by a partial memory for displaying only a part of the display panel 3, as well known.

The display panel 3 includes a plurality of data lines 4, a plurality of scanning lines 5, pixels 6 arrayed in a matrix manner and common electrode lines 7. The pixels 6 are arrayed at intersections of the plurality of data lines 4 and the plurality of scanning lines 5. The pixel 6 includes a display electrode, a common electrode opposing to the display electrode and a TFT (“thin film transistor”) serving as a switch device. The TFT is connected at a drain thereof to the display electrode, at a gate thereof to the scanning line 5, and at a source thereof to the data line 4. A liquid crystal layer or an organic EL layer is interposed between the display electrode and the common electrode. The common electrode line 7 is connected to the common electrode. The scanning line drive circuit 2 drives the scanning lines 5 in order. The data line drive circuit 1 receives the digital signal from the CPU, and then stores it. Also, the data line drive circuit 1 converts the digital signal into an analog gradation signal when each of the scanning lines 5 is driven, and supplies the analog gradation signals to the pixels 6 through the data lines 4 in the display panel 3 at one time. Consequently, the video image can be displayed on the entire display panel 3.

FIG. 3 is a block diagram showing the configuration of the data line drive circuit 1. The data line drive circuit 1 incorporates a logic unit 8, a drive unit 9 and a power source circuit 11. The power source circuit 11 is connected to both of the logic unit 8 and the drive unit 9.

The power source circuit 11 supplies different power source voltages to the logic unit 8 and the drive unit 9, respectively. For example, the power source voltages to be supplied to the logic unit 8 and the drive unit 9 are 3 V or lower and 3 V or higher, respectively. Although the power source voltage of 3 V or lower is generally used in an integrated circuit, the power source voltage of 3 V or higher is required for a drive voltage in the liquid crystal display apparatus. On the other hand, the power source voltage is supplied from a battery in a mobile phone, and its supplied voltage (i.e., VDC) is generally 3 V or lower. For this reason, a power source circuit is needed for generating a power source voltage to be supplied to the drive unit 9.

In addition, a driving method is known, in which a polarity of a pixel voltage to be applied from the data line 4 to the pixel 6 is inverted for every predetermined time period in the liquid crystal display apparatus. In other words, the pixel 6 is possibly driven in an AC manner. Here, the polarity expresses a plus or a minus of the pixel voltage with respect to a voltage of the common electrode (i.e., a Vcom voltage) of the liquid crystal. Such a driving method is used for preventing any degradation of a material of the liquid crystal. As the above-described AC driving method, a dot inversion driving method is known, in which a DC voltage is applied to the Vcom voltage, and the polarity of an analog gradation signal to be supplied to the data line 4 are inverted for every scanning line or every frame. In addition, a common inversion driving method is also known, in which the Vcom voltage is inverted every scanning line. In either case, the power source circuit 11 generates the Vcom voltage.

The power source circuit 11 includes a constant voltage generating circuit (not shown), and a DC/DC converter circuit (not shown) composed of switches and capacitances. The above-described voltage VDC is supplied to a constant voltage generating circuit, which generates a constant voltage. Based on the voltage, the DCDC converter circuit generates a logic voltage, a drive voltage and the voltage Vcom with respect to a system ground (abbreviated as “an SGND”). The system ground is the common power source in the power source circuit 11, to be supplied to the power source circuit 11, the logic unit 8 and the drive unit 9. The logic voltage is a power source voltage of 3 V or lower with respect to the system ground, to be supplied to the logic unit 8. The drive voltage is a power source voltage of 3 V or higher with respect to the system ground, to be supplied to the drive unit 9. The voltage Vcom represents a common voltage with respect to the system ground, and is supplied to the common electrode line 7.

If noise is propagated to the system ground (i.e., SGND) or the constant voltage generating circuit, the noise is propagated also to the Vcom voltage, which is supplied from the power source circuit 11 to the common electrode in the display panel 3. As a result, a quality of an image is degraded due to a flicker or a crosstalk. This noise is generated inside the drive circuit, and a peak value of the noise is increased or decreased according to a change in digital signal. In order to suppress the occurrence of the noise in the logic unit 8 and the drive unit 9, it is effective that a peak current value at the time of a signal processing is decreased. From this viewpoint, in the logic unit 8, the gradation data of one display line on the display panel 3 is not read from the display memory circuit 13 at one time, but it is preferable that the gradation data of one display line on the display panel 3 is read out from the display memory circuit 13 in units of blocks of p pixels (p is a natural number) from a first block to an n-th block (n is an integer). In the following description, three pixels R, G and B are referred to as one block, namely, p is 3.

Next, the logic unit 8 will be described below. The logic unit 8 includes a signal processing circuit 12, the display memory circuit 13, a data calculating circuit 14, a latch circuit A 15, another latch circuit B 16, a buffer circuit 20 and data buses 21 and 22.

The signal processing circuit 12 is connected to each of circuits disposed in the logic unit 8 and the drive unit 9. The signal processing circuit 122 receives the digital signal supplied from the CPU. The digital signal include a signal of gradation data representing a gradation of each of the pixels, the command signal, the address control signal and a signal of a logic calculating process command. In the first embodiment, the gradation data corresponding to one pixel 6 consists of 18 bits, that is, 6 bits (64-gradation) for each of red, green and blue colors. The command signal includes a write command and a read command to the display memory circuit 13. The address control signal includes write and read start addresses to the display memory circuit 13. The signal processing circuit 12 produces a memory control signal based on the above-described signals, horizontal and vertical clock signals, described later, or the like. The gradation data and the memory control signal are supplied to the display memory circuit 13. In addition, the command signal includes a clock frequency setting signal for setting a clock frequency. In this case, the signal processing circuit 12 is provided with an oscillation circuit (not shown), which produces clock control signals such as a horizontal clock signal (i.e., an HCLK signal), a vertical clock signal (i.e., a VCLK signal), a horizontal start signal, a vertical start signal and a latch signal (i.e., an STB signal) based on the clock frequency setting signal. The signal processing circuit 12 supplies the clock control signal to the circuits inside of the logic unit 8 and the drive unit 9 in the data line drive circuit 1 and to the scanning line drive circuit 2. Furthermore, the command signals include a binary mode signal for displaying an image on the display panel 3 in a binary mode, a standby mode signal for displaying the same image on the display panel 3, and a partial mode signal for partially displaying the image at only a part of the display panel 3. The signal processing circuit 12 produces a mode control signal for setting an operational mode based on the command signal. Additionally, the signal processing circuit 12 supplies the mode control signal to both of the D/A converting circuit 18 and the gradation voltage generating circuit 19 in the drive unit 9.

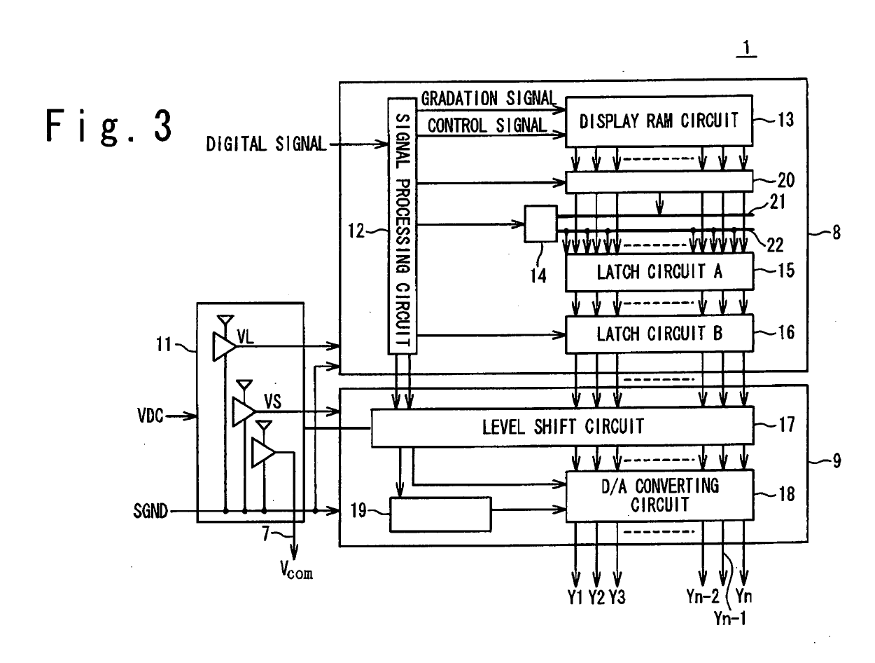

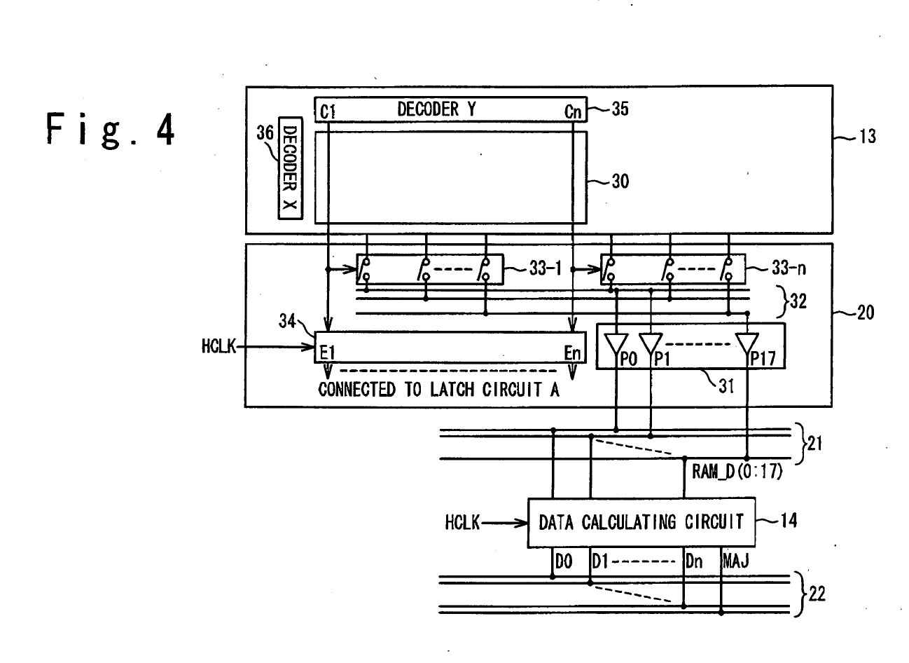

As described above, the display memory circuit 13 is a circuit for storing the gradation data for one frame. FIG. 4 is a block diagram showing the display memory circuit 13. As shown in FIG. 4, the display memory circuit 13 includes a RAM (“random access memory”) 30 such as an SRAM, a Y address decoder 35 and an X address decoder 36. Initial pixel addresses when the RAM 30 is accessed are set in the address decoders 35 and 36, respectively, by the signal processing circuit 12. Upon receipt of the memory control signal from the signal processing circuit 12, the X address decoder 36 designates one row in the RAM 30 based on the initial pixel address. In contrast, upon receipt of the memory control signal from the signal processing circuit 12, the Y address decoder 35 designates a designated pixel address of the designated row in the RAM 30 based on the initial pixel address, in general, a first pixel address. Thereafter, every time the Y address decoder 35 receives the memory control signal from the signal processing circuit 12, the Y address decoder 35 designates the pixel address on the designated row in the RAM 30 in order. At this time, the Y address decoder 35 outputs column address signals C1 to Cn.

When the memory control signal from the signal processing circuit 12 includes a write command, the address decoders 35 and 36 select an address in the RAM 30 in response to the memory control signal. Thereafter, the gradation data is written in the selected address. In this manner, the RAM 30 stores the gradation data for one frame of the display panel 3. In contrast, when the memory control signal from the signal processing circuit 12 includes a read command to the drive unit 9, the address decoders 35 and 36 select an address in a column and a row in the RAM 30 in response to the memory control signal. Then, the gradation data is read out from the selected address. The read gradation data is supplied to the buffer circuit 20.

The buffer circuit 20 supplies the gradation data read out from the display memory circuit 13 to the data bus 21 or the latch circuit A 15. As shown in FIG. 4, the buffer circuit 20 is provided with a sense amplifier section 31, a data bus 32, a selector section 33 and a delay circuit section 34. The data bus 32 includes 18 signal lines for the gradation data of 18 bits for each of the pixels. The selector section 33 includes the same number of selectors 33-1 to 33-n as that of pixels on one display line. Each of the selectors includes 18 switches. The switch in the selector is turned off in response to the row address signal outputted from the display memory circuit 13, and the gradation data of one pixel is supplied to the data bus 32. The sense amplifier section 31 is connected to the data bus 32, and includes sense amplifiers P0 to P17 corresponding to the gradation data of 18 bits to each of the pixels. As described above, the sense amplifiers are provided for three pixels in the drive circuit according to the present invention. As a consequence, the number of sense amplifiers can be remarkably reduced, unlike the conventional example in which the sense amplifier is provided for each bit in the display memory circuit 13. Thus, the size of the drive circuit can be reduced. Each of the sense amplifiers P0 to P17 amplifies the gradation data of 18 bits on the data bus 32, and then supplies it onto another data bus 21. The delay circuit section 34 delays an address signal Cj (1≦j≦n) outputted from the display memory circuit 13 by a horizontal clock period, and supplies the delayed address signal Ej to the latch circuit A 15. In other words, the delay circuit section 34 holds the address signal Cj outputted from the display memory circuit 13, and thereafter, supplies the address signal Cj as a sampling signal Ej to the latch circuit A 15 in response to the HCLK signal.

As shown in FIG. 4, the data bus 21 includes the 18 signal lines for the amplified gradation data RAM_D (0:17) of 18 bits. Also, the data bus 22 includes 19 signal lines, that is, 18 signal lines corresponding to display pixel data D (0:17) of 18 bits and one signal line corresponding to a majority signal (i.e., an MAJ signal) of one bit. The display pixel data D (0:17) of 18 bits and the MAJ signal are outputted as “display pixel data & MAJ signal” from the data calculating circuit 14.

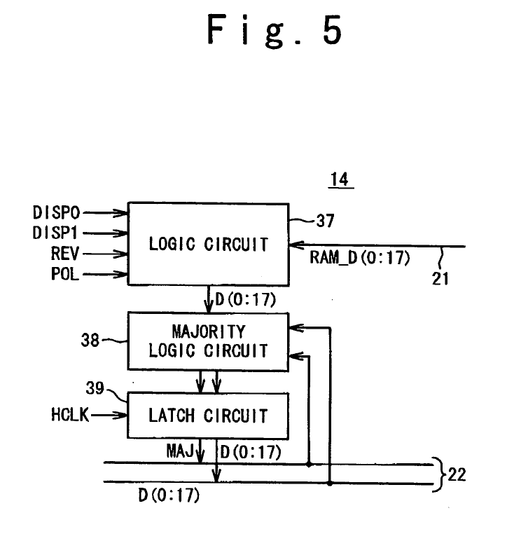

FIG. 5 is a block diagram showing the detail of the data calculating circuit 14. As shown in FIG. 5, the data calculating circuit 14 is provided with a logic circuit 37, a majority calculating circuit 38 and a latch circuit 39. The logic circuit 37 and the majority logic circuit 38 can be implemented by a logic circuit such as OR circuits, AND circuits or EXOR circuits. The logic circuit 37 carries out a predetermined logical calculating process to the gradation data RAM_D (0:17) outputted from the buffer circuit 20 and supplies it to the majority logic circuit 38. The predetermined logic calculating process is at least one of a polarity reversing process POL, an reversing process REV, an all-black process DISP0 and an all-white process DISP1, and is designated in response to a logic calculating process command issued from the signal processing circuit 12. In the polarity reversing process POL, a bit-reversing process is carried out to the gradation data for AC-driving a liquid crystal. In the reversing process REV, a color of a video image is reversed to a completely contrary color, that is, bits of the gradation data are reversed. In the all-black or all-white process, a signal indicating black or white is outputted irrespective of the gradation data. The majority logic circuit 38 carries out a majority calculating process MAJ to be described later to the display pixel data D (0:17) outputted from the logic circuit 37, and supplies the display pixel data D (0:17) to be described later, and the MAJ signal to be described later, to the latch circuit 39. The latch circuit 39 delays the display pixel data D (0:17) and the MAJ signal outputted from the majority logic circuit 38 by the horizontal clock period, and then supplies them to the latch circuit A 15. In other words, the latch circuit 39 holds the display pixel data D (0:17) and the MAJ signal outputted from the majority logic circuit 38, and then, supplies them to the latch circuit A 15 through the data bus 22 in response to the HCLK signal. The processing order by the logic circuit in the data calculating circuit 14 is, for example, an order from the reversing process REV, the all-black process DISP0, the all-white process DISP1, the polarity reversing process POL and the majority calculating process MAJ. In this manner, an another logic circuit may be added as long as the last two processes are the polarity reversing process POL and the majority calculating process MAJ in this order. Here, “the gradation data” is a data of the digital signal stored in the display memory circuit 13, and therefore, it is distinguished from the gradation data of the signal outputted through the data calculating circuit 14 or the latch circuit A 15, which is referred to as “the display pixel data”.

The latch circuit A 15 calculates the EXOR between the MAJ signal and each of the bits of the display pixel data D (0:17) when the display pixel data and the MAJ signal are supplied onto the data bus 22 from the data calculating circuit 14. That is, the latch circuit A 15 holds the display pixel data D (0:17) as it is without reversing the display pixel data D (0:17) in accordance with a non-reversion command “0” expressed by the MAJ signal. In contrast, when the MAJ signal is “1”, the latch circuit A 15 bit-reverses and holds the display pixel data D (0:17), which is subjected to the majority calculating process MAJ, in accordance with a reverse command “1” expressed by the MAJ signal. In the meantime, sampling signal En is supplied from the delay circuit section 34 in the buffer circuit 20 to the latch circuit A 15. The latch circuit A 15 supplies the held display pixel data to another latch circuit B 16 in response to the sampling signal En.

Next, the majority calculating process MAJ will be described below. The majority logic circuit 38 receives a previous display pixel data D (0:17) from the data bus 22 and a current display pixel data D (0:17) from the logic circuit 37, respectively. Then, the majority logic circuit 38 carries out the majority calculating process to both of the previous display pixel data D (0:17) of 18 bits and the current display pixel data D (0:17) of 18 bits. Thereafter, the majority logic circuit 38 compares each of the bits of the previous display pixel data D (0:17) with a corresponding one of the bits of the current display pixel data D (0:17), and determines whether the number of reversed bits of the current display pixel data D (0:17) is greater or smaller than a majority. If the number of reversed bits is greater than the majority, the majority logic circuit 38 reverses ones of the bits of the previous display pixel data D (0:17) corresponding to the non-reversed bits. In addition, the majority logic circuit 38 generates the MAJ signal indicating the reverse command “1” and supplies the display pixel data D (0:17) after the majority calculating process MAJ and the MAJ signal “1” to the latch circuit 39. In contrast, if the number of reversed bits is smaller than the majority, the majority logic circuit 38 generates the MAJ signal indicating the non-reverse command “0”, and supplies the current display pixel data D (0:17) and the MAJ signal “0” to the latch circuit 39. The latch circuit 39 holds the display pixel data D (0:17) and the MAJ signal “0”, and outputs them onto the data bus 22, in synchronism with the horizontal clock signal HCLK.

An example will be described below, in which the display pixel data has 4 bits and a signal (the display pixel data of 4 bits and the MAJ signal of 1 bit) is supplied to the data bus 22. It is supposed that the previous display pixel data is a (0000) while the current display pixel data is b (1101). In this case, the three bits of the display pixel data b (1101) are changed from 0 to 1 in comparison with the display pixel data a (0000). As described above, when it is determined in the majority calculating process that the bits of the display pixel data greater than the majority are changed, the majority logic circuit 38 reverses the bits of the data a (0000) corresponding to the non-reversed bits of the bits of the display pixel data b (1101) to generate display pixel data b′ (0010). At the same time, the MAJ signal is set to “1”. The display pixel data b′ (0010) and the MAJ signal “1” as the display pixel data & the MAJ signal (0010;1) are outputted to the data bus 22 through the latch circuit 39. Upon receipt of the display pixel data & the MAJ signal (0010;1) supplied to the data bus 22, the latch circuit A 15 reverses the display pixel data b′ (0010) in accordance with the MAJ signal “1” and holds the display pixel data b (1101). As a result, the three bits are reversed unless the majority calculating process MAJ is carried out. However, only the two bits are reversed, containing the MAJ signal, if the majority calculating process MAJ is carried out. Thus, the power for charge/discharge can be reduced on the data bus 22.

When the display pixel data includes the even number of bits, the number of bits to be changed may be equal in some cases. At that time, the process is performed such that the MAJ signal cannot be changed. For example, when the gradation data to be supplied from the display memory circuit 13 to the data bus 21 is changed in the order of a (0000), b (1100), c (0011) and d (1010), the majority logic circuit 38 supplies the display pixel data & the MAJ signal a′ (0000;0), b′ (1100;0), c′ (1100;1) and d′ (0101;1) to the data bus 22 through the latch circuit 39. Although two of the bits of the gradation data are changed in the process from a to b, the gradation data cannot be bit-reversed with the MAJ signal “0” even at b′ since the MAJ signal of a′ is “0”. Furthermore, although two bits are changed also in the process from c to d, the gradation data is bit-reversed with the MAJ signal “1” since the MAJ signal of c′ is “1”.

In the latch circuit A 15, a decoder is required in an address control system, compared with a serial transfer system in which the sampling signal is generated in a shift register circuit and the gradation data is latched in order. For example, a decoder of 8 bits is required in order to drive the data lines 4 of 256×3 (i.e., R, G and B colors). Such a decoder of 8 bits is larger in circuit size than the shift register circuit. However, according to the present invention, the address decoders 35 and 36 in the display memory circuit 13 are used as the decoder of 8 bits, thereby suppressing increase in circuit size. The address control system may be applied to the scanning line drive circuit 2. An off display region on a partial display may be skip-scanned, and the plurality of scanning lines 5 may be activated at the same time.

The latch circuit B 16 holds the display pixel data from the latch circuit A 15, and supplies the held display pixel data to the drive unit 9 at a time in response to a latch signal (i.e., the STB signal) from the signal processing circuit 12.

Next, the drive unit 9 will be described. The drive unit 9 includes a level shift circuit 17, a D/A converting circuit 18 and a gradation voltage generating circuit 19. The level shift circuit 17 is connected to the latch circuit B 16, the D/A converting circuit 18 and the gradation voltage generating circuit 19. The level shift circuit 17 converts a logic voltage level of the display pixel data from the latch circuit B 16 into a drive voltage level.

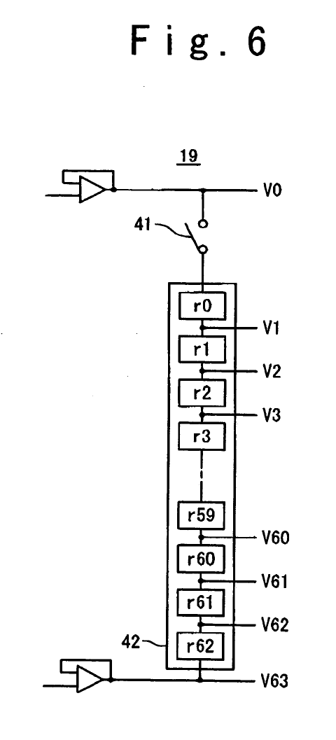

As shown in FIG. 6, the gradation voltage generating circuit 19 is provided with a switch 41, a resistance voltage dividing circuit 42, a first buffer amplifier for supplying a first reference voltage V0 and a second buffer amplifier for supplying a second reference voltage V63. The resistance voltage dividing circuit 42 includes 63 resistors r0 to r62, which are connected in series to each other. The switch 41 is connected at one end thereof to the first reference voltage V0: In contrast, the switch 41 is connected at the other end thereof to one end of the resistor r0. The resistor r62 is connected at one end thereof to the second reference voltage V63. In a normal drive mode, in which no mode control signal inclusive of a binary mode signal or a standby signal for designating a first reference voltage V0 or a second reference voltage V63 is supplied, the switch 41 is turned on. In this case, the resistance voltage dividing circuit 42 divides the two reference voltages V0 and V63 by the 63 resistors r0 to r62 in such a manner as to match with gamma characteristic, thereby generating 64 gradation voltages different from each other. Here, although the reference voltages are simplified to the two reference voltages V0 and V63, a plurality of reference voltages in addition to the reference voltages V0 and V63 may be supplied to the resistance voltage dividing circuit 42. When the above-described mode control signal is supplied, that is, in a low power drive mode, the switch 41 is turned off, so that a current flowing in the resistance voltage dividing circuit 42 is cut off, thereby reducing consumed power.

As described above, the logic unit 8 operates in the logic voltage supplied from the power source circuit 11, whereas the drive unit 9 operates in the drive voltage supplied from the power source circuit 11. Namely, the voltage levels in the logic unit 8 and the drive unit 9 are different from each other. Therefore, the level shift circuit 17 converts the logic voltage level of the display pixel data from the latch circuit B 16 into the drive voltage level.

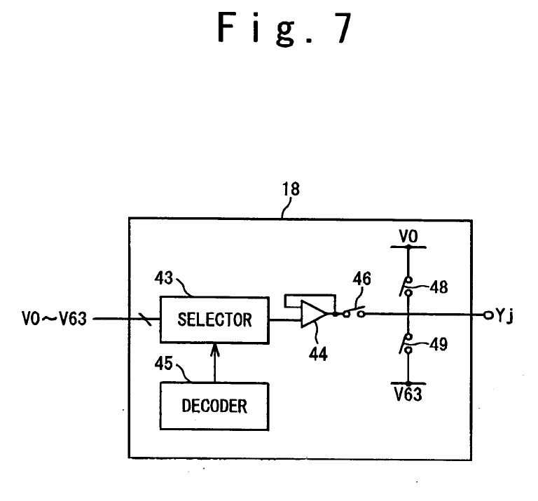

The D/A converting circuit 18 converts the display pixel data into an analog gradation signal. The D/A converting circuit 18 includes 3×n D/A converters for one display line. As shown in FIG. 7, each of the 3×n D/A converters is provided with a selector 43, a buffer amplifier 44, a decoder 45 and switches 46, 48 and 49. The decoder 45 is connected to the level shift circuit 17. The selector 43 is connected to the gradation voltage generating circuit 19 and the decoder 45. The buffer amplifier 44 is connected at an input thereof to the selector 43 and at an output thereof to one end of the switch 46. The switch 46 is connected at the other end thereof to a data line Yj (1≦j≦3n) serving as the data line 4. Furthermore, the D/A converting circuit 18 may be constituted of the n D/A converters, to drive the data line Yj (1≦j≦3n) in 3 time divisions. In this case, a time division switch (not shown) is interposed between the D/A converting circuit 18 and the data line 4, to transfer the gradation data for each pixel from the display memory circuit 13.

In the above-described normal drive mode in which no mode control signal is supplied, the switch 46 is turned on while the other switches 48 and 49 are turned off. In this case, the decoder 45 decodes the display pixel data supplied from the latch circuit B 16 through the level shift circuit 17, and outputs the decoded result to the selector 43. The selector 43 selects a predetermined one of the 64 gradation voltages supplied from the gradation voltage generating circuit 19 in accordance with the display pixel data from the decoder 45. The buffer amplifier 44 supplies the selected gradation voltage to a corresponding pixel 6 on the display panel 3 through the data line Yj.

On the other hand, in the low power drive mode in which the mode control signal inclusive of the binary mode signal is supplied, the switch 46 is turned off so as to cut off the bias current in the buffer amplifier 44 while the other switch 48 or 49 is turned on to supply the reference voltage (V0 or V63) to the given pixel 6 on the display panel 3 through the data line Yj.

It should be noted that when the selected gradation voltage is amplified by setting a gain (i.e., a ratio of an output signal to an input signal) of the buffer amplifier in the D/A converting circuit 18 to a value more than 1, the level shift circuit 17 can be omitted. Otherwise, although the D/A converting circuit 18 converts the display pixel data into the analog gradation voltage signal in the data line drive circuit 1, a circuit for generating an analog gradation current signal-based on the display pixel data may be used in place of the above-described D/A converting circuit 18.

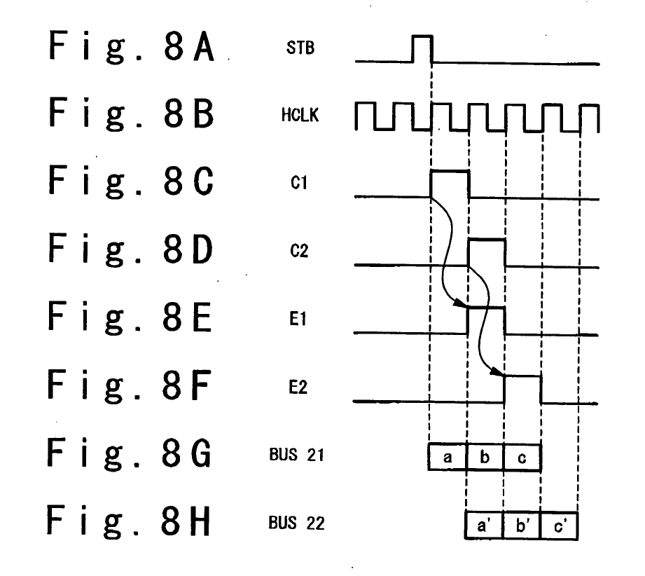

FIGS. 8A to 8H are timing charts illustrating the operation of the display apparatus according to the first embodiment of the present invention. Referring to FIGS. 8A to 8H, it is supposed that the gradation data for one frame of the display panel 3 is stored in the RAM 30 in the display memory circuit 13. The signal processing circuit 12 outputs the STB signal to the latch circuit B 16, and supplies the memory control signal inclusive of the read command to the display memory circuit 13. At this time, the address decoders 35 and 36 in the display memory circuit 13 select n address signals C1 to Cn indicative of the first to n-th addresses for one row in the RAM 30 in this order in response to the memory control signal supplied from the signal processing circuit 12. Then, the address decoders 35 and 36 outputs the n address signals C1 to Cn in this order to the buffer circuit 20. The RAM 30 outputs to the buffer circuit 20, n gradation data a, b, c, . . . corresponding to the first to n-th pixels 6 for one display line of the display panel 3 in this order. The buffer circuit 20 sequentially supplies the first to n-th gradation data a, b, c, . . . to the data bus 21 in this order. Moreover, the buffer circuit 20 holds the n address signals C1 to Cn in this order, delays them by a preset clock (i.e., the HCLK signal), and then outputs the n sampling signals E1 to En to the latch circuit A 15 in order. The data calculating circuit 14 carries out the logic calculating process and the majority calculating process MAJ to the n gradation data a, b, c, . . . in this order, delays them by the predetermined clock (i.e., the HCLK signal), and then supplies the n display pixel data a′, b′, c′, . . . in this order to the data bus 22. Here, when bits corresponding to the j-th display pixel data are reversed and the number of reversed bits is greater than the majority in comparison with each of bits of (j−1)-th display pixel data, the data calculating circuit 14 carries out the majority calculating process MAJ for reversing bits of the (j−1)-th display pixel data corresponding to non-reversed bits of the j-th display pixel data, and then supplies the reversed (j−1)-th display pixel data as the j-th display pixel data and the MAJ signal representing the reverse command “1” for the latch circuit A 15 to the data bus 22. The latch circuit A 15 holds the n display pixel data a′, b′, c′, . . . supplied to the data bus 22 in this order, delays them by the predetermined clock (i.e., the n-th sampling signals E1 to En), and then outputs the n display pixel data a′, b′, c′, . . . in this order to the latch circuit B 16. Here, the latch circuit A 15 reverses and holds the j-th display pixel data subjected to the majority calculating process MAJ in accordance with the MAJ signal “1”, delays it by the predetermined clock (i.e., a sampling signals Ej), and then outputs it to the latch circuit B 16. The latch circuit B 16 holds the n display pixel data a′, b′, c′, . . . supplied from the latch circuit A 15 in this order, and outputs the n display pixel data a′, b′, c′, . . . to the drive unit 9 at one time in response to the STB signal supplied from the signal processing circuit 12. The D/A converting circuit 18 in the drive unit 9 selects a preset one of the 64 gradation voltages supplied from the gradation voltage generating circuit 19, corresponding to each of the n display pixel data a′, b′, c′, . . . supplied from the latch circuit B 16, and supplies them to first to 3n-th pixels 6 for one display line of the display panel 3 through data lines Y1 to Y3n.

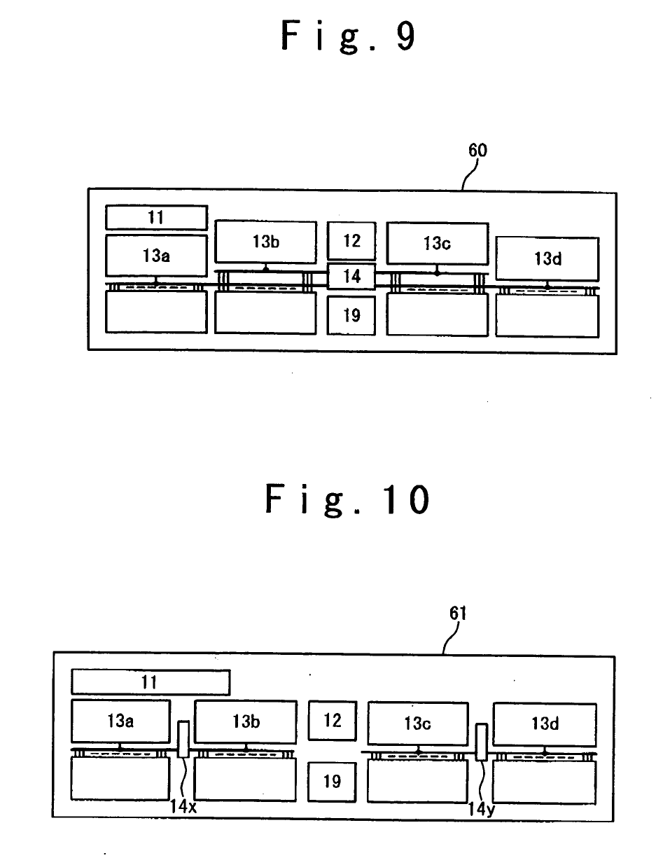

The above-described drive circuit may be integrated on the same substrate or chip). FIGS. 9 and 10 show examples in which the data line drive circuit 1 is integrated on a semiconductor substrate of silicon. In an integrated circuit 60 illustrated in FIG. 9, the data calculating circuit 14, the power source circuit 11, the signal processing circuit 12 and the gradation voltage generating circuit 19 are arranged at one portion of the integrated circuit 60. Here, the display memory circuit 13 is divided into four blocks, that is, display memory circuits 13a, 13b, 13c and 13d, which are dispersedly arranged on the integrated circuit 60. Although not shown, the buffer circuit 20, the latch circuit A 15, the latch circuit B 16, the level shift circuit 17 and the D/A converting circuit 18 are divided into four blocks in the same manner as the display memory circuits 13a, 13b, 13c and 13d, respectively. Thus, the above circuits are arranged on the integrated circuit 60. In addition, the data buses 21 and 22 are divided into four blocks in the same manner as the display memory circuits 13a, 13b, 13c and 13d, respectively, and are arranged on the integrated circuit 60. Thus, these circuits are connected to the data calculating circuit 14. Since the display memory circuit 13 is divided into the four blocks, the gradation data at the time of division of one display line into four parts are simultaneously processed by the data calculating circuit 14.

In an integrated circuit 61 shown in FIG. 10, the data calculating circuit 14 is disposed at two portions on the integrated circuit 61, unlike the above-described integrated circuit 60. Specifically, it is supposed that the data calculating circuit 14 is replaced with data calculating circuits 14x and 14y. In this case, the data calculating circuit 14x is connected to the two blocks of the four blocks of the data buses 21 and 22 corresponding to the display memory circuits 13a and 13b. On the other hand, the other data calculating circuit 14y is connected to the remaining two blocks of the four blocks of the data buses 21 and 22 corresponding to the display memory circuits 13c and 13d. As a consequence, a wiring capacity can be reduced by shortening a wiring of each of the data buses 21 and 22. Thus, the charge/discharge power of the data buses 21 and 22 can be reduced. In this manner, the integration can reduce the number of component parts, thereby improving the reliability of the display apparatus.

As described above, according to the present invention, the gradation data for one display line of the display panel 3 are divided into the first to n-th gradation data, are read out in order from the display memory circuit 13, and then are outputted to the latch circuit B 16 through the buffer circuit 20, the data buses 21 and 22, the data calculating circuit 14 and the latch circuit A 15 in the logic unit 8, unlike the gradation data for one display line of the display panel 3 are read out at one time from the display memory circuit 13 and outputted to the latch circuit B 16 in the logic unit 8. Consequently, since the number of sense amplifiers can be reduced to 1/n, the operation current can be also reduced to 1/n. Thus, it is possible to reduce the transient current, to reduce a noise generation quantity, to supply the stable Vcom voltage to the common electrode of the display panel 3 from the power source circuit 11, and to improve the quality of the image, since the signal processes are not performed simultaneously, unlike a case that the buffer circuit 20, the data calculating circuit 14 and the latch circuit A 15 carries out the signal processes to the gradation data for one display line at one time. In this case, the data calculating circuit 14 needs not to carry out the logic calculating process to the gradation data for one display line at one time, and carries out the signal process (e.g., the logic calculating process and the majority calculating process) to the first to n-th gradation data for one display line in order. Thus, the circuit size of the data calculating circuit 14 can be reduced more than that of the conventional example of data calculating circuit 84.

Furthermore, according to the present invention, the data calculating circuit 14 carries out the majority calculating process in the logic unit 8. Thus, the charge/discharge power to the data bus 22 can be reduced.

### Second Embodiment

Next, the drive circuit according to the second embodiment of the present invention will be described. The description of the same components as those of the first embodiment will be omitted below, and only different points will be described.

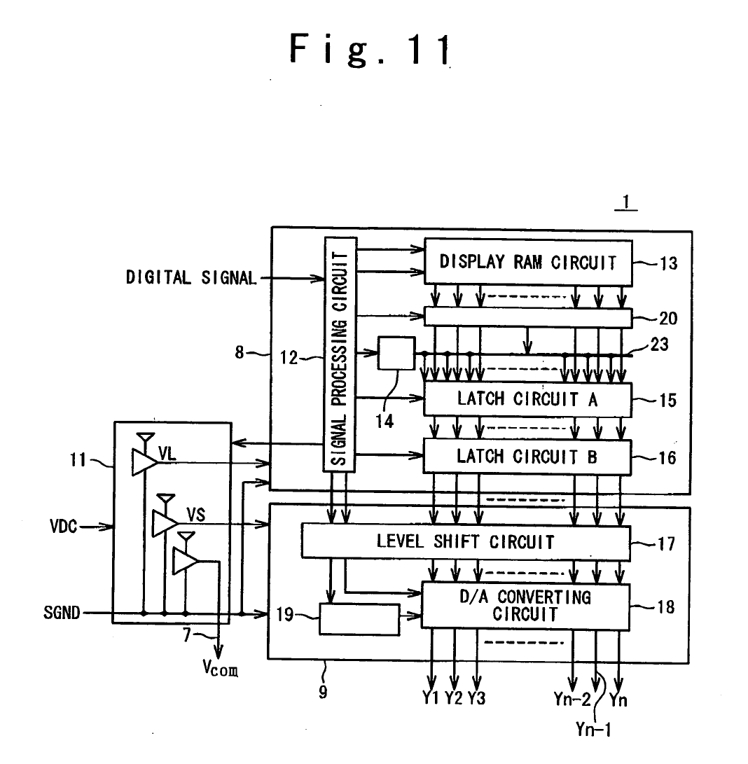

FIG. 11 is a block diagram illustrating the configuration of the drive circuit for the display apparatus in the second embodiment. Although the two groups of the data buses 21 and 22 are provided in the first embodiment, a single data bus 23 is provided and is shared in the second embodiment. Xn other words, gradation data is supplied from the display memory circuit 13 to the data calculating circuit 14 through the buffer circuit 20 and the data bus 23, and display pixel data, which has been subjected to a predetermined signal process in the data calculating circuit 14, is also supplied to the data latch circuit A 15 through the data bus 23. The buffer circuit 20 and the data calculating circuit 14 alternately use the data bus 23 in order to prevent their outputs from interfering with each other. Switches (not shown) are provided between the sense amplifier section 31 and the data bus 23 and between an output of the data calculating circuit 14 and the data bus 23, respectively. The switch can be alternately set to a first connection mode, in which the sense amplifier section 31 and the data bus 23 are connected to each other, and to a second connection mode, in which the output of the data calculating circuit 14 and the data bus 23 are connected to each other, in response to the HCLK signal outputted from the signal processing circuit 12. Although a data transmissivity is halved in comparison with in the first embodiment, the number of data buses can be reduced.

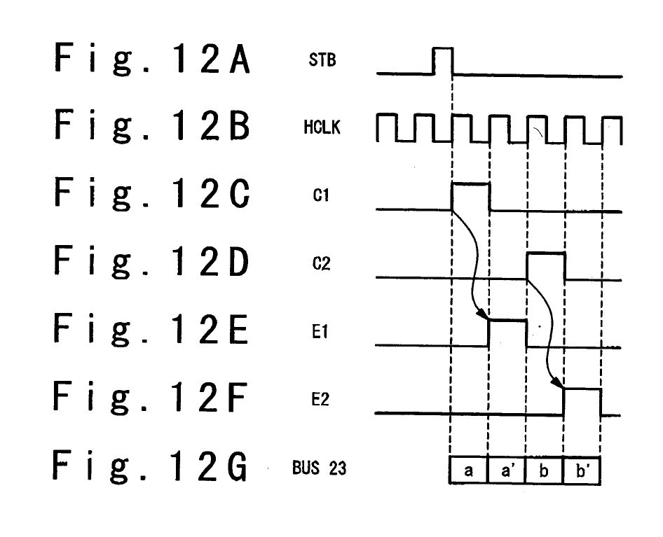

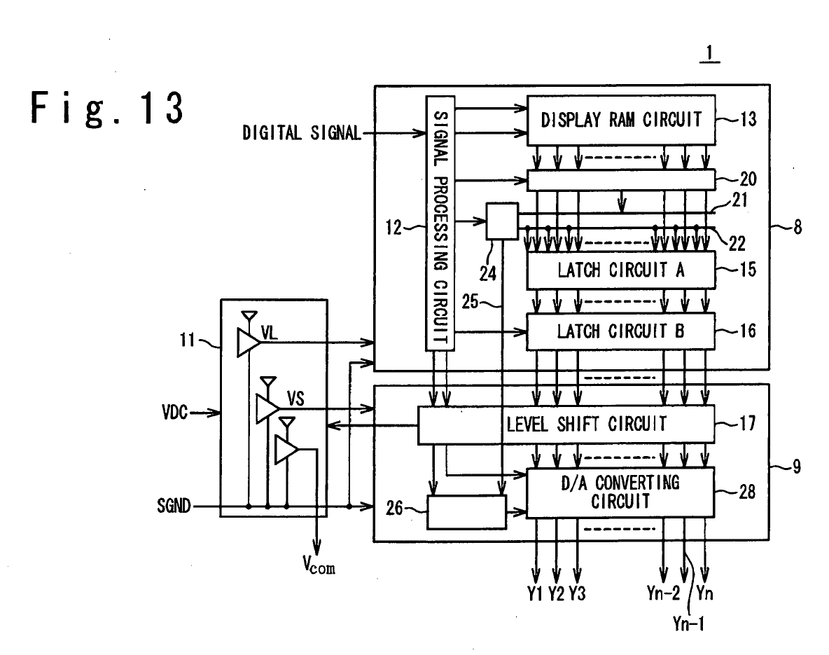

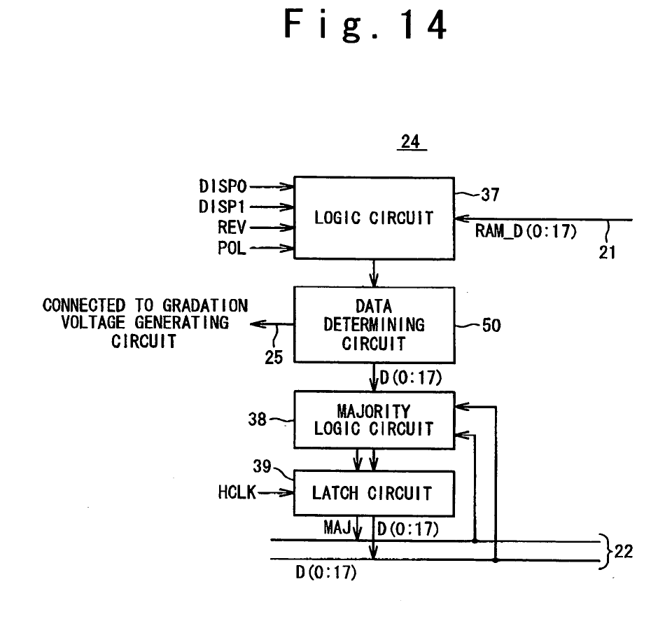

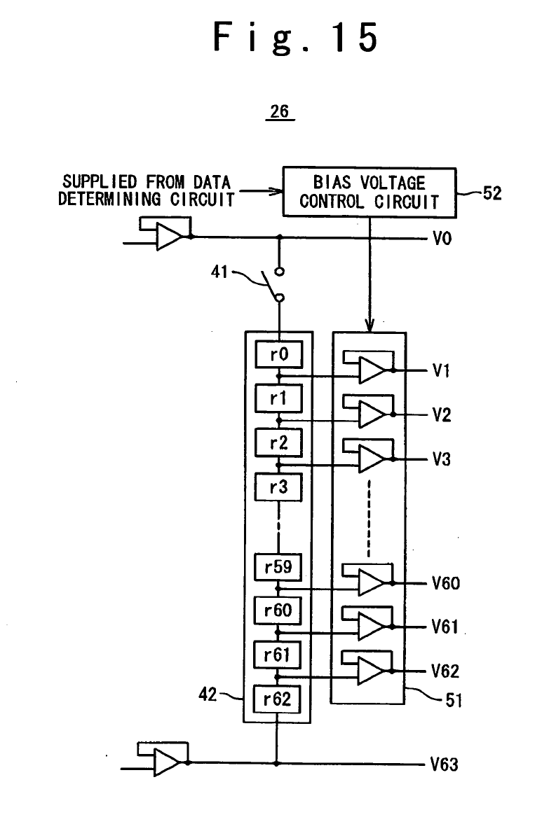

FIGS. 12A to 12G are timing charts illustrating the shared data bus. The gradation data a from the display memory circuit 13 is selected in response to the address signal C1. The selected gradation data is supplied to the data calculating circuit 14 through the sense amplifier section 31 and the data bus 23 in the first connection mode. Display pixel data a′, which has been subjected to a predetermined signal process in the data calculating circuit 14, is supplied to the data latch circuit A 15 through the data bus 23 in response to a sampling signal E1 with a delay for 1 clock period in the second connection mode.

### Third Embodiment

Next, the drive circuit according to the third embodiment of the present invention will be described below in detail. The description of the same components as those of the first embodiment will be omitted below, and only different points will be explained. FIG. 13 is a block diagram illustrating the configuration of the drive circuit for the display apparatus in the third embodiment. Differences from the first embodiment are present in that the logic unit 8 includes a data calculating circuit 24 in place of the data calculating circuit 14 and additionally includes a determination signal bus 25. Furthermore, the drive unit 9 includes a gradation voltage generating circuit 26 in place of the gradation voltage generating circuit 19 and a D/A converting circuit 28 in place of the D/A converting circuit 18.

As shown in FIG. 14, the data calculating circuit 24 is configured such that a data determining circuit 50 is interposed between the logic circuit 37 and the majority logic circuit 38 in addition to the above-described configuration of the data calculating circuit 14. The data determining circuit 50 is adapted to determine each of bits of display pixel data, and outputs a determination signal expressing a determination result through the determination signal bus 25. The determination signal bus 25 has 64 signals in case of the display pixel data of 6 bits, and each of the 64 signals is made active or inactive based on the display pixel data.

As shown in FIG. 15, the gradation voltage generating circuit 26 is provided with a bias voltage control circuit 52 and a buffer amplifier section 51 in addition to the configuration of the above-described gradation voltage generating circuit 19. The buffer amplifier section 51 includes a plurality of buffer amplifiers corresponding to a plurality of gradation voltages other than reference voltages V0 and V63. The bias voltage control circuit 52 controls a bias current of each of the plurality of buffer amplifiers in the buffer amplifier section 51 in response to the 64 signals outputted from the data determining circuit 50. In other words, the 62 buffer amplifiers output 62 gradation voltages V1 to V62 generated by the resistance voltage dividing circuit 42 at the time of activation, respectively.

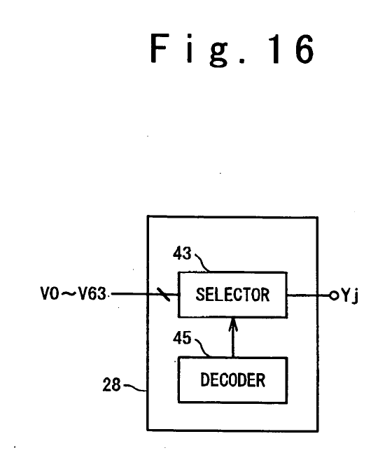

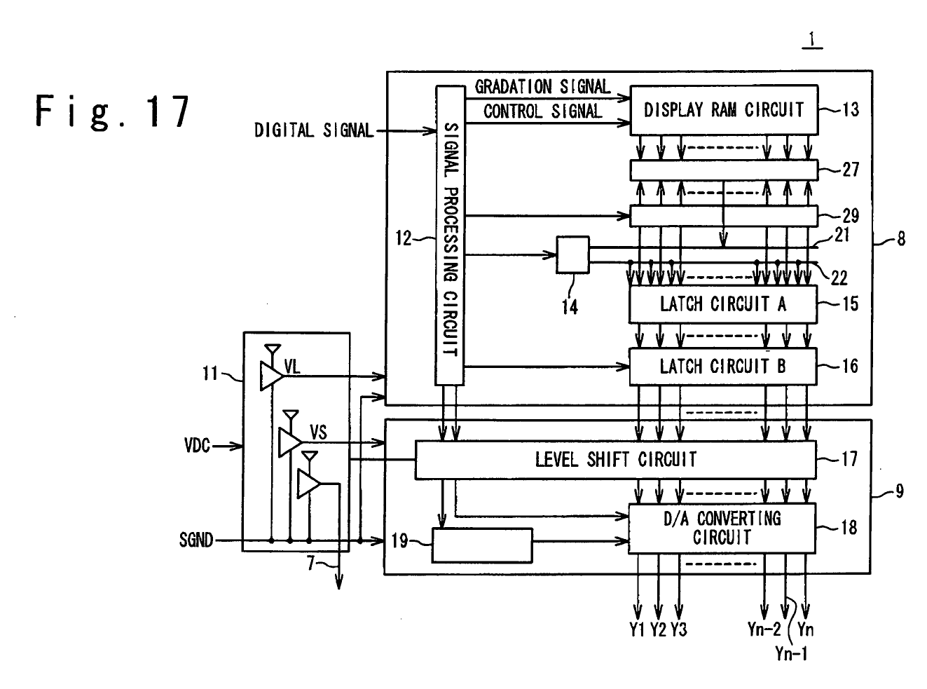

As shown in FIG. 16, the buffer amplifier 44 and the switches 46, 48 and 49 are omitted from the D/A converting circuit 28, unlike the D/A converting circuit 18.

The data determining circuit 50 determines the display pixel data outputted from the logic circuit 37, and outputs a determination signal to the determination signal bus 25. For example, when the determination signal indicates a black display on all of the data lines for an arbitrary one horizontal period, the bias voltage control circuit 52 activates only a buffer amplifier corresponding to a 0-gradation voltage while inactivates buffer amplifiers corresponding to other gradation voltages (i.e., from a 1-gradation voltage to a 63-gradation voltage) of the plurality of buffer amplifiers in the buffer amplifier section 51 in response to the determination signal. Otherwise, the bias voltage control circuit 52 activates only buffer amplifiers corresponding to the gradation voltages V0, V63 and V31 at the time of display at only an intermediate gradation voltage V31 while inactivates the buffer amplifiers corresponding to other gradation voltages (i.e., V1 to V30 and V32 to V62). Since the gradation voltages other than the gradation voltages V0 and V63 are generated in reference to the gradation voltages V0 and V63, the buffer amplifiers corresponding to the gradation voltages V0 and V63 are made active other than all-black display and all-white display. As a consequence, a bias current of the buffer amplifier corresponding to the gradation voltage which does not need for the display can be cut off, thereby reducing the electric power consumption.

### Fourth Embodiment

Next, the drive circuit according to the fourth embodiment of the present invention will be described below. The description of the same components as those of the first embodiment will be omitted below, and only different points will be described. FIG. 17 is a block diagram illustrating the configuration of the drive circuit for the display apparatus in the fourth embodiment. Differences from the first embodiment are present in that the logic unit 8 includes a buffer circuit 27 in place of the buffer circuit 20, and additionally includes a shift register circuit 29 interposed between the buffer circuit 27 and the display memory circuit 13.

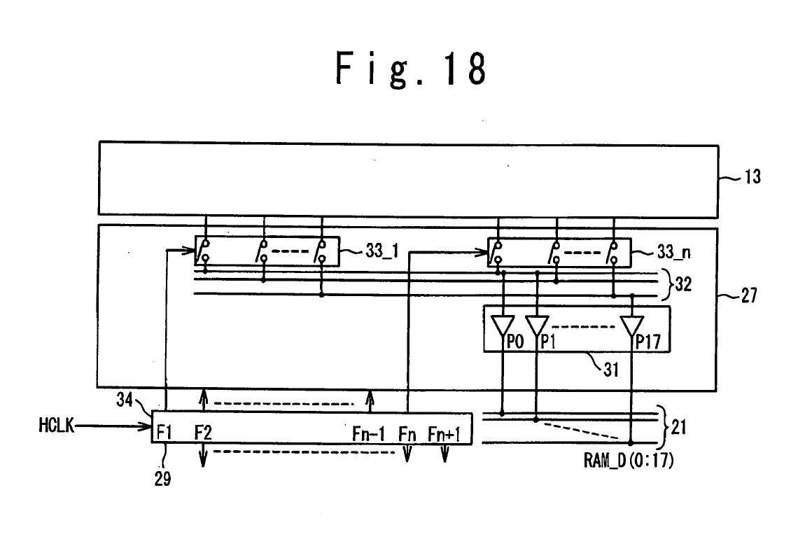

As shown in FIG. 18, the delay circuit section 34 is omitted from the buffer circuit 27, and instead, the shift register circuit 29 is disposed in the logic unit 8, unlike the above-described buffer circuit 20.

The signal processing circuit 12 supplies the above-described HCLK signal and the start signal to the shift register circuit 29. In this case, the shift register circuit 29 latches an output from the Y address decoder 35 as a sampling signal Fj in response to the HCLK signal and the start signal, and outputs it to the latch circuit A 15 and a selector section 33-j in a selector group of the display memory circuit 13 in order. In the fourth embodiment, an input sampling signal of display pixel data to the data latch circuit A 15 is delayed by one clock period from a reading sampling signal of the gradation data from the display memory circuit 13. The sampling signals F1, F2, . . . Fn each designate the reading sampling signal of the gradation data from the display memory circuit 13, and the signals F2, F3, . . . F(n+1) each denote the sampling signal of the display pixel data to the data latch circuit A 15. The number of clocks to be delayed is determined in accordance with a calculating process performed by the data calculating circuit 14.

Although the present invention has been described above, the above embodiments may be arbitrarily combined without inconsistency. The integrated circuit including the drive circuit according to the present invention may be integrated on substrates made of glass, plastic and the like other than the semiconductor substrate made of silicon. Furthermore, although the display pixel data has 6 bits (i.e., the 64 gradation levels) in the above-described embodiments, the display pixel data may have 5 bits or less or 7 bits or more. Additionally, although the liquid crystal display apparatus has been mainly described, the present invention may be applied to another display apparatus such as an organic EL display apparatus.

Also, according to the present invention, it is possible to reduce noise caused by a transient current generated inside of the drive circuit and to improve image quality in the display apparatus.

Also, according to the present invention, gradation data for one display line of the display apparatus is divided into first to n-th data, are read out in order from a memory 13 of a logic unit 8, and then the data is outputted to the latch circuit B 16 through the buffer circuit 20, the data buses 21, 22 and 23, the data calculating circuits 14 and 24 and the latch circuit A 15. In this manner, the number of sense amplifiers can be reduced to 1/n, and operation current can be also reduced to 1/n. In comparison with a case that the buffer circuit 20, the data calculating circuits 14 and 24 and the latch circuit A 15 carry out a signal process to the gradation data for one display line at one time, a noise generation quantity can be reduced by decreasing a peak value of the transient current since the signal process is not simultaneously performed. Consequently, a stable Vcom voltage can be supplied from the power source circuit 11 to a common electrode 7 in the display apparatus, thereby improving the image quality.

In this case, the data calculating circuits 14 and 24 need not to carry out the logic calculating process to the gradation data for one display line at one time, but carry out the signal process to the first to n-th gradation data for one display line in order. Thus, the data calculating circuits 14 and 24 can be reduced in size more than the conventional data calculating circuit 84.

In addition, according to the present invention, the data calculating circuit 14 performs [symbol] [symbol] majority calculating process in the logic unit 8, so that charge/discharge power can be reduced in the data buses 22 and 23.

Additionally, according to the present invention, the data calculating circuit 24 distinguishes display pixel data, so as to control supply of a bias current at the buffer amplifier 51 corresponding to an unnecessary gradation in the logic unit 8, thus reducing a consumed power.

What is claimed is:

1. A drive circuit comprising:
a logic section comprising a data bus and a display memory circuit and configured to read out a plurality of gradation data from said display memory circuit through said data bus and to collectively output said plurality of gradation data as display pixel data; and
a drive section configured to drive a display unit based on analog gradation signals which are generated based on said display pixel data outputted from said logic section.

2. The drive circuit according to claim 1, further comprising:
a power supply circuit configured to supply at least one of first and second power supply voltages to said logic section and said drive section,
wherein said logic section, said drive section and said power supply circuit are formed in a same semiconductor chip.

3. The drive circuit according to claim 1, wherein said logic section comprises:
p sense amplifiers (p is a natural number) provided between said display memory circuit and said data bus; and
a buffer circuit configured to output said plurality of gradation data read out from said display memory circuit onto said data bus in units of p pixels.

4. The drive circuit according to claim 3, wherein said display memory circuit comprises:
memory cells arranged in a matrix; and
a column decoder configured to sequentially generate sampling signals to columns of the matrix in response to a horizontal clock signal,
said buffer circuit comprises:
a switch section provided between said columns and said sense amplifier and configured to operate in response to said sampling signals, and
said plurality of gradation data read out from said display memory circuit are sequentially outputted said p sense amplifiers.

5. The drive circuit according to claim 1, wherein said logic section comprises:
a data calculating circuit configure to carry out a first calculation to each of said plurality of gradation data, to selectively generate a process instruction based on a result of said first calculation and to output said first calculation result and said process instruction; and
a first holding circuit configured to hold said first calculation result for one display line of said display unit, to carry out a second calculation to said first calculation result held therein when said process instruction is outputted, and to hold and output a second calculation result as said display pixel data.

6. The drive circuit according to claim 5, wherein the first calculation is a majority operation between a previous gradation data and a current gradation data.

7. The drive circuit according to claim 6, wherein said data bus comprises:
a first data bus on which said plurality of gradation data are outputted from said sense amplifiers; and
a second data bus on which said second calculation result and said process instruction are outputted from said data calculating circuit.

8. The drive circuit according to claim 7, wherein said data calculating circuit comprises:
a second holding circuit configured to hold said second calculation result and said process instruction to output onto said second data bus; and
a majority operation circuit configured to execute said majority operation of whether bits inverted between said second calculation result and said current gradation data is major and to output said process instruction to said second holding circuit when the inverted bits are major.

9. The drive circuit according to claim 8, wherein said data calculating circuit further comprises:
a logic circuit configured to carry out a conversion to said current gradation data on said first data bus in response to a mode instruction to output to said majority operation circuit.

10. The drive circuit according to claim 6, wherein said data bus is a single bus, and
said data calculating circuit comprises:
a second holding circuit configured to hold and output said first calculation result and said process instruction to said data bus; and
a majority operation circuit configured to carry out a majority operation of whether bits inverted between said first calculation result to said previous gradation data and said current gradation data is major, and to generate and output said process instruction to said second holding circuit when the inverted bits are major.

11. The drive circuit according to claim 10, wherein said data calculating circuit further comprises:
a logic circuit configured to carry out a conversion process to said current gradation data on said data bus in response to a mode indication to output to said majority operation circuit.

12. The drive circuit according to claim 5, wherein said drive section comprises:
a level shift circuit configured to carry out a level shift of said display pixel data for one display line of said display unit;
a gradation voltage generating circuit configured to generate gradation voltages for a predetermined number; and
a D/A converting circuit provided for each of said columns and configured to select one of said gradation voltages for the predetermined number based on each of said display pixel data after the level shift and to drive said display unit based on the selected gradation voltage.

13. The drive circuit according to claim 12, wherein said D/A converting circuit comprises:
a decoder circuit configured to decode said display pixel data;
a selector configured to select one of said gradation voltages for the predetermined number based on the decoding result; and
a switch section configured to supply the selected gradation voltage to said display unit.

14. The drive circuit according to claim 13, wherein said gradation voltage generating circuit comprises:
at least two reference voltages; and
a voltage dividing resistance circuit configured to divide a reference voltage difference.

15. The drive circuit according to claim 9, wherein said data calculating circuit further comprises:
a data distinction circuit provided between said logic circuit and said majority operation circuit and configured to decode said plurality of gradation data to output a distinction signal while outputting said plurality of gradation data from said logic circuit to said majority operation circuit,
said gradation voltage generating circuit comprises:
at least two reference voltages;
a voltage dividing resistance circuit configured to divide a reference voltage difference;
a group of buffer amplifiers configured to amplify an output of said voltage dividing resistance circuit; and
a bias voltage control circuit configured to activate one of said buffer amplifiers of the group based on said distinction signal such that said gradation voltage corresponding to said display pixel data is outputted.

16. The drive circuit according to claim 15, wherein said D/A converting circuit comprises:
a decoder configured to decode said display pixel data; and
a selector configured to supply one of said gradation voltages for the predetermined number to said display unit based on the decoding result.

17. A driving method of a display unit, comprising:
sequentially reading out a plurality of gradation data in units of p pixels (p is a natural number) from a display memory circuit;
generating display pixel data obtained by carrying out a calculation process to said plurality of gradation data; and
driving said display unit in response to analog gradation signals generated based on said display pixel data

18. The driving method according to claim 17, wherein said generating comprises:
carrying out a first calculation to each of said plurality of gradation data;
selectively generating a process instruction based on a result of said first calculation;
holding said first calculation result for one display line of said display unit;
carrying out a second calculation to said first calculation result in response to said process instruction; and
generating a second calculation result as said display pixel data.

19. The driving method according to claim 18, wherein said first calculation is a majority operation between a previous gradation data and a current gradation data.
